(19) United States
(12) Patent Application Publication
(10) Pub. No.: US 2008/0155151 A1
(43) Pub. Date: Jun. 26, 2008

(54) Programmable Locking Mechanism For Secure Applications In An Integrated Circuit

(75) Inventors: John A. Fifield, Underhill, VT (US); Steven F. Oakland, Colchester, VT (US); Michael R. Ouellette, Westford, VT (US)

Correspondence Address: DOWNS RACHLIN MARTIN PLLC, 199 MAIN ST, PO BO 190, BURLINGTON, VT, 05402-0190, US

(73) Assignee: INTERNATIONAL BUSINESS MACHINES CORPORATION, Armonk, NY (US)

(21) Appl. No.: 11/615,137

(22) Filed: Dec. 22, 2006

(51) Int. Cl. G06F 21/00

(52) U.S. Cl. 710/200

(57) ABSTRACT

A programmable locking mechanism for use in an integrated circuit is disclosed. In particular, the programmable locking mechanism may include an access code storage circuit for storing a security access code and a code input register whose outputs feed a comparator circuit that generates a locking signal. The state of the locking signal depends on whether the contents of the access code storage circuit and the code input register match. Additionally, a blocking circuit is provided that interrupts a programming input to the access code storage circuit and, thus, allows or denies access via the programming input to the access code storage circuit depending on the state of the locking signal. Additionally, the locking signal is distributed to sensitive logic circuits within the integrated circuit for preventing and/or allowing (depending on state) access thereto.

### FIELD OF THE DISCLOSURE

The present disclosure generally relates to the field of security in integrated circuits. In particular, the present disclosure is directed to a programmable locking mechanism for secure applications in an integrated circuit.

### BACKGROUND

A locking mechanism, such as a security access code mechanism, may be used in an integrated circuit (IC) in order to prevent an unauthorized entity from, for example, determining the state of sensitive logic on an IC chip when the IC chip is in use. In particular, for end users, such as card manufacturers, a security concern arises from having the chip manufacturers program the locking mechanism at wafer or module final test. Consequently, end users are continuously seeking increased capability to secure an IC chip at higher levels of assembly, such as at card or system level assembly.

A need exists for a programmable locking mechanism for secure applications in an integrated circuit, in order to prevent unauthorized access to a security code with which the locking mechanism may be unlocked.

### SUMMARY OF THE DISCLOSURE

In one embodiment, a programmable locking mechanism for an integrated circuit is provided. The locking mechanism includes an access code storage circuit for storing an access code, said access code storage circuit having a programming input for programming the access code into said access code storage circuit; a code input register for receiving an input code; a comparator circuit in communication with said access code storage circuit and said code input register, said comparator circuit having a output, said comparator circuit comparing the access code to the input code and generating an unlock signal to said output when the input code matches the access code and generating a lock signal to said output when the input code does not match the access code; and a blocking circuit having a first input in communication with said output, said blocking circuit being configured to block access to reading or modifying the access code via said programming input when said output includes a lock signal.

In another embodiment, a programmable locking mechanism for an integrated circuit is provided. The locking mechanism includes an access code storage circuit for storing an access code, said access code storage circuit including: one or more e-fuses, each of said one or more e-fuses configured to include an access code bit of said access code; a fuse blow enable input to said one or more e-fuses for controlling access to programming said one or more e-fuses; and an fsource input for programming said one or more e-fuses; a code input register for receiving a input code; a comparator circuit in communication with said access code storage circuit and said code input register, said comparator circuit having a output, said comparator circuit comparing the access code to the input code and generating an unlock signal to said output when the input code matches the access code and generating a lock signal to said output when the input code does not match the access code; and a blocking circuit having a first input in communication with said output, said blocking circuit being configured to block access to reading or modifying the access code via said programming input when said output includes a lock signal.

In yet another embodiment, a programmable locking mechanism for an integrated circuit. The locking mechanism includes an access code storage circuit for storing an access code, said access code storage circuit including: one or more e-fuses, each of said one or more e-fuses configured to include an access code bit of said access code; a fuse blow enable input to said one or more e-fuses for controlling access to programming said one or more e-fuses; and an fsource input for programming said one or more e-fuses; a code input register for receiving an input code; a comparator circuit in communication with said access code storage circuit and said code input register, said comparator circuit having a output, said comparator circuit comparing the access code to the input code and generating an unlock signal to said output when the input code matches the access code and generating a lock signal to said output when the input code does not match the access code; and a blocking circuit having a first input in communication with said output, said blocking circuit being configured to block access to reading the access code via said programming input by blocking said fuse blow enable input when said output includes a lock signal.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a high level block diagram of one embodiment of a programmable locking mechanism for secure applications in an integrated circuit;

FIG. 2 illustrates a high level block diagram of another embodiment of a programmable locking mechanism in an integrated circuit; and

FIG. 3 illustrates a high level block diagram of yet another embodiment of a programmable locking mechanism in an integrated circuit.

### DETAILED DESCRIPTION

In one embodiment, the present disclosure includes a programmable locking mechanism for use in an integrated circuit. In particular, the programmable locking mechanism may include an access code storage circuit for storing a security access code and a code input register the outputs of each feeding a comparator circuit that generates a locking signal. The state of the locking signal depends on whether the contents of the access code storage circuit and the code input register match. In one example, where the contents of the access code storage circuit and the code input register match, the locking signal may have an inactive state (e.g., generating an unlock signal). In another example, where the contents of the access code storage circuit and the code input register do not match, the locking signal may have an active state (e.g., generating a lock signal). Additionally, a blocking circuit is provided that allows or denies access to the access code storage circuit depending on the state of the locking signal. Additionally, the locking signal is distributed to sensitive logic circuits within the integrated circuit for preventing and/or allowing (depending on state) access thereto. In one example, only when a user provides an input code to the code input register that matches the contents of the access code storage circuit is the contents of the access code storage circuit and/or the sensitive logic circuits allowed to be read and/or updated in the field.

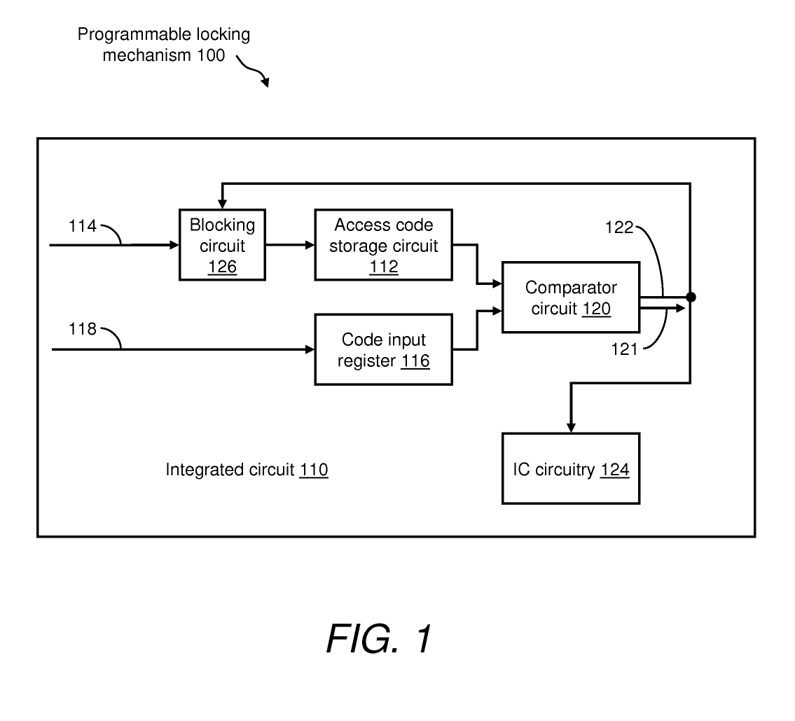

FIG. 1 illustrates a high level block diagram of one embodiment of a programmable locking mechanism 100 for secure applications in an integrated circuit, such as within an integrated circuit 110. Programmable locking mechanism 100 may include an access code storage circuit 112, which may be fed by a programming input 114. Programming input 114 provides one or more pathways for programming an access code into access code storage circuit 112. In certain situations it may also be possible to manipulate programming input 114 to allow the access code to be read out of access code storage circuit 112. As discussed further below, programmable locking mechanism 100 is configured to prevent access to reading an access code via programming input 114. Access code storage circuit 112 may be any of a variety of multi-bit storage device into which a security access code may be programmed. Example multi-bit storage devices may include, but are not limited to, an electronic fuse (eFuse) circuit, an antifuse circuit, a flash memory, a ferrite memory, any other type of non-volatile memory, and any combinations thereof. Access code storage circuit 112 may include any number of bits; however, the greater the number of bits, the greater the number of, for example, binary combinations, and, thus, the greater the security level. In one example, access code storage circuit 112 may be a 128-bit storage device.

Programmable locking mechanism 100 may further include a code input register 116, which may be any register device that is capable of latching an input code 118 (e.g., an input code of at least the same number of bits as stored in access code storage circuit 112). In one example, when access code storage circuit is a 128-bit storage device, code input register 116 may be a 128-bit register for storing an 128-bit input code 118, which may be, for example, a serial or parallel input.

An output of access code storage circuit 112 feeds a first input of a comparator circuit 120 and an output of code input register 116 feeds a second input of comparator circuit 120. In one example, the outputs of access code storage circuit 112 and code input register 116 may each provide a serial or parallel input to comparator circuit 120. Comparator circuit 120 may be any digital comparator circuit for comparing at least two input values, such as two binary sets of n-bits. Comparator circuit 120 includes an output 121 for outputting a generated locking signal 122. In one example, when access code storage circuit 112 and code input register 116 are 128-bit devices, comparator circuit 120 may be a 128-bit comparator for comparing the two 128-bit words. Comparator circuit 120 generates an output locking signal 122 that may be a lock signal when the contents of access code storage circuit 112 and code input register 116 are not an exact match. By contrast, when the contents of access code storage circuit 112 and code input register 116 are an exact match, locking signal 122 may be an unlock signal state. In one example, when locking signal 122=a logical 1 value it may be a lock signal and when locking signal 122=a logical 0 value it may be an unlock signal. In another example, when locking signal 122=a logical 0 value it may be a lock signal and when locking signal 122=a logical 1 value it may be an unlock signal.

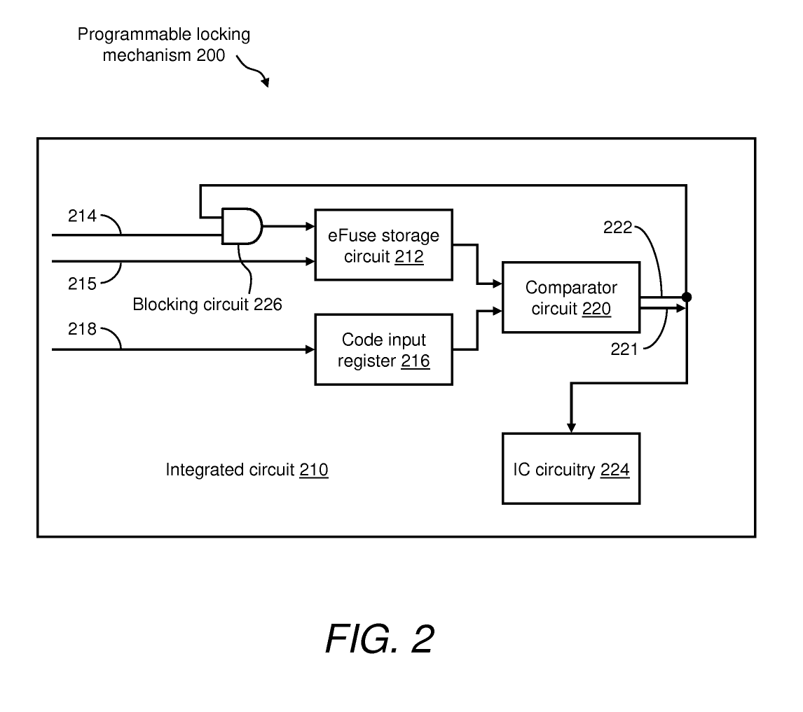

Locking signal 122 is distributed via output 121 of comparator circuit 120 to IC circuitry 124, which may be sensitive logic within integrated circuit 110 for which it is desired to control access. Locking signal 122 may be utilized to switch access restriction circuitry depending on the state of locking signal 122. Access restriction circuitry for blocking access to IC circuitry 124 is known to those of ordinary skill. Additionally, output 121 of comparator circuit 120 is physically and electrically connected to an input of a blocking circuit 126 that is configured to block access to reading an access code stored in access code storage circuit 112 by blocking the ability to read the access code via programming input 114. In one example, blocking circuit 126 is configured to physically block electrical transmission over programming input 114. In another example (discussed further below with respect to FIG. 2), blocking circuit 126 modifies the ability for the access code to be read over programming input 114 without physically blocking programming input 114 itself. When locking signal 122 is a lock signal (e.g., when comparator circuit 120 generates a lock signal) any manipulation of programming input 114 is ignored and, thus, the contents of access code storage circuit 112 may not be accessed via programming input 114.

In operation, in one example, integrated circuit 110 upon which is installed a programmable locking mechanism, such as programmable locking mechanism 100, is provided to the user with a security code that is preprogrammed, for example, at time of manufacturing test, within access code storage circuit 112. Subsequently, the user may install integrated circuit 110 within a card or system assembly. A user then provides input code 118 that is then stored within code input register 116. The contents of code input register 116 is compared to the contents of access code storage circuit 112 by use of comparator circuit 120. If the contents match exactly, locking signal 122 becomes an unlock signal and access to sensitive circuitry, such as IC circuitry 124, and to the security code storage device itself, such as to access code storage circuit 112, is authorized. By contrast, if the contents do not match exactly, locking signal 122 remains a lock signal and access to sensitive circuitry, such as IC circuitry 124, and to the security code storage device itself, such as to access code storage circuit 112, is blocked via blocking circuit 126.

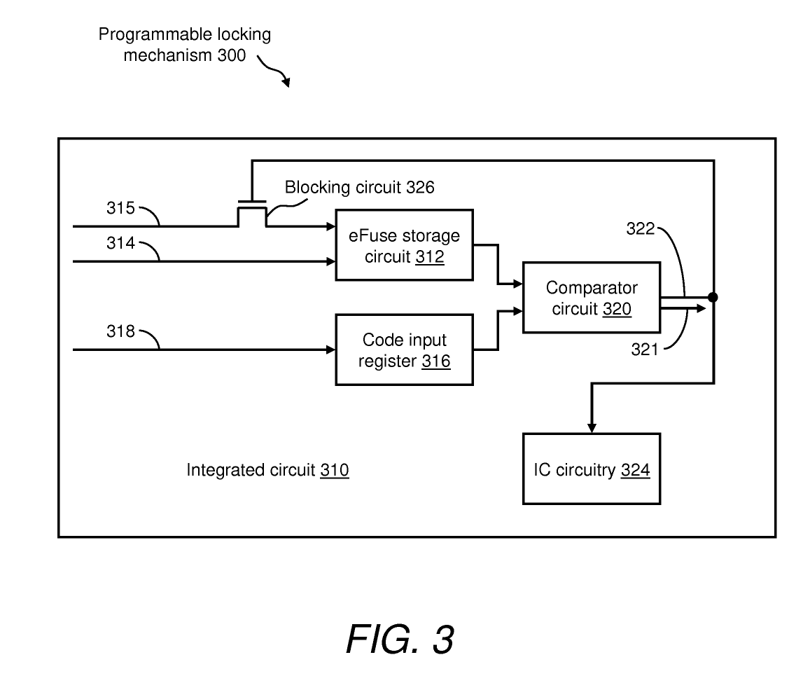

An exemplary aspect of programmable locking mechanism 100 may provide improved security capability by use of the combination of access code storage circuit 112, code input register 116, and comparator circuit 120 in order to generate a locking mechanism, such as the signal LOCK, for controlling access to the sensitive circuitry within an integrated circuit, such as IC circuitry 124 of integrated circuit 110, as well as for controlling access to the security code storage device itself, such as to access code storage circuit 112 via blocking circuit 126. More details of example embodiments of programmable locking mechanisms may be found with reference to FIGS. 2 and 3.

FIG. 2 illustrates a high level block diagram of a programmable locking mechanism 200, which is another example of a programmable locking mechanism in an integrated circuit, such as within an integrated circuit 210. Programmable locking mechanism 200 may include an access code storage circuit 212 including a one or more eFuses for storing an access code. EFuse storage circuit 212 may be a multi-bit eFuse circuit that is used as a multi-bit storage device into which a security code may be programmed. In particular, eFuse storage circuit 212 may include one or more eFuses that are blown to a value that reflects, for example, a security access code. EFuse storage circuit 212 may include any number of bits; however, the greater the number of bits, the greater the number of, for example, binary combinations, and, thus, the greater the security level. In one example, eFuse storage circuit 212 may be a 128-bit storage device. Programmable locking mechanism 200 may further include a code input register 216 that is capable of latching an input code 218 (e.g., an input code of at least the same number of bits as stored in access code storage circuit 212). In one example, when access code storage circuit is a 128-bit storage device, code input register 216 may be a 128-bit register for storing an 128-bit input code 218, which may be, for example, a serial or parallel input.

EFuse access code storage circuit 212 may include any of a variety of access code storage circuit configuration including eFuses that are known in the art. In one example, access code storage circuit 212 may include a set of eFuses in electrical communication with a set of latches, with each eFuse having at least a corresponding respective one of the set of latches. The values of the bits stored in the eFuses may be sensed from the eFuses to the latches via sense circuitry, as is known in the art. The latches of the access code storage circuit 212 may then be compared with bits representing an input code as discussed above with respect to comparator circuit 220 of FIG. 1 and in further detail below with respect to programmable locking mechanism 200.

Efuse access code storage circuit 212 may include a fuse blow enable input 214 for enabling one or more of the eFuses in access code storage circuit 212 to be electronically programmed selectively to include an appropriate bit of an access code to be stored therein. Fuse blow enable input 214 may be connected to, and/or include, circuitry (e.g., a programming NFET per eFuse) that is known in the art for providing the selectivity of programming the eFuses. Efuse access code storage circuit 212 may also include a programming input 215 (e.g., Fsource) for providing a programming voltage to one or more selected eFuses in access code storage circuit 212. The selectivity circuitry associated with fuse blow enable input 214 (depending on the state of a signal carried on fuse blow enable input 214 and as is known in the art) prevents the programming voltage of programming input 215 from programming (i.e., “blowing”) particular eFuses.

In one example, an output of eFuse storage circuit 212 may feed a first input of a comparator circuit 220 and an output of code input register 216 feeds a second input of comparator circuit 220. In another example, the outputs of eFuse storage circuit 212 and code input register 216 may each provide a serial or parallel input to comparator circuit 220. In still yet another example, the outputs of each of a set of latches in access code storage circuit 212 may be compared with the outputs of each of a set of latches in code input register 216 via comparator circuit 220. Comparator circuit 220 may be substantially identical to comparator circuit 120 of FIG. 1. Comparator circuit 220 includes an output 221 for outputting a generated locking signal 222. In one example, when eFuse storage circuit 212 and code input register 216 are 128-bit devices, comparator circuit 220 may be a 128-bit comparator for comparing the two 128-bit words. Similar to comparator circuit 120 of FIG. 1, comparator circuit 220 generates an output locking signal 222 that may be a lock signal when the contents of eFuse storage circuit 212 and code input register 216 are not an exact match. By contrast, when the contents of eFuse storage circuit 212 and code input register 216 are an exact match, locking signal 222 may be an unlock signal.

The locking signal 222 is distributed via output 221 of comparator circuit 220 to IC circuitry 224, which may be sensitive logic within integrated circuit 210 for which it is desired to control access. Locking signal 222 may be utilized to switch access restriction circuitry depending on the state of locking signal 222. Access restriction circuitry for blocking access to IC circuitry 224 is known to those of ordinary skill. Additionally, output 221 of comparator circuit 220 is physically and electrically connected to a first input of a blocking circuit 226 (e.g., one or more logic gates, such as an AND gate, which may be a 2-input AND gate), that is configured to block access to reading an access code stored in eFuse storage circuit 212 by blocking the ability to read the access code via programming input 215, the Fsource. In particular, where blocking circuit 226 is an AND gate, fuse blow enable input 214 is electrically connected to a second input of AND gate 226 and provides a logical high output to selectivity circuitry of the eFuses of access code storage circuit 212 when the logical values of the two inputs to the AND gate are high. Thus, when fuse blow enable input 214 carries a logical high (e.g., a logical “1”) signal to enable fuse blow within access code storage circuit 212, locking signal 222 must include a logical high value to allow the fuse blow enable signal to reach the selectivity circuitry of the eFuses of access code storage circuit 212. In this example, comparator circuit 220 generates an unlock signal that includes a logical high value. Those of ordinary skill will recognize multiple variations of a blocking circuit 226 including one or more circuit elements, such as one or more logic gates, for allowing an unlock signal to include a logical low value (i.e., a logical “0”). If comparator circuit 220 generates a lock signal having a logical low value, then the output of AND gate 226 will be a logical low, which will not enable the selectivity circuits to allow a programming voltage from programming input 215 to pass to the eFuses of access code storage circuit 212. This will also block access via programming input 215 to reading any values stored in the eFuses of access code storage circuit 212 by disabling selectivity circuitry (e.g., a programming NFET per eFuse) such that there is no electrical connectivity between the eFuse bit value and the programming input 215.

For example, during an eFuse blow operation, fsource voltage input 215 that is set to a certain voltage level may be steered to a certain programming NFET of a certain eFuse by the selectivity circuitry that is controlled by fuse blow enable input 214. When the programming NFET associated with the eFuse is turned on for a certain duration of time electromigration occurs, in effect programming the eFuse (i.e., “blowing” the eFuse). Fuse blow enable input 214 is connected to a second input of AND gate 226 and is, therefore, gated by locking signal 222, which in this example may be a logical 0 value when locking signal 222 is a lock signal. Consequently, when locking signal 222 is a lock signal the ANDing function of AND gate 226 is not satisfied and, thus, any manipulation of fuse blow enable programming signal 214 and fsource voltage input 215 is ignored because the programming NFETS are controlled to the off states. In this way, the contents of eFuse storage circuit 212 is blocked from being sensed or modified. In an alternative example, the polarity of locking signal 222 and fuse blow enable programming signal 214 may be inverted and AND gate 226 may be a negative AND gate.

In operational example, integrated circuit 210 upon which is installed a programmable locking mechanism, such as programmable locking mechanism 200, is provided to the user with a security code that is preprogrammed, for example, at time of manufacturing test, within eFuse storage circuit 212. Subsequently, the user may install integrated circuit 210 within a card or system assembly. A user then provides an input code via input 218 that is then within code input register 216. The contents of code input register 216 are compared to the contents of eFuse storage circuit 212 by use of comparator circuit 220. If the contents match exactly, locking signal 222 is an unlock signal and access to sensitive circuitry, such as IC circuitry 224, and to the security code storage device itself, such as to eFuse storage circuit 212, is authorized. By contrast, if the contents do not match exactly, locking signal 222 is a lock signal and access to sensitive circuitry, such as IC circuitry 224, and to the security code storage device itself, such as to eFuse storage circuit 212, is blocked via AND gate 226.

FIG. 3 illustrates a high level block diagram of a programmable locking mechanism 300, which is another example of a programmable locking mechanism in an integrated circuit, such as within an integrated circuit 310. Programmable locking mechanism 300 may include an eFuse storage circuit 312, which is another example of an access code storage circuit, a code input register 316 that is fed by an input code 318, a comparator circuit 320, and IC circuitry 324. EFuse storage circuit 312, code input register 316, comparator circuit 320, and IC circuitry 324 may be substantially identical to eFuse storage circuit 212, code input register 216, comparator circuit 220, and IC circuitry 224 of FIG. 2.

Comparator circuit 320 includes an output 321 for outputting a generated locking signal 322. Additionally, generated locking signal 322 from comparator circuit 320 is physically and electrically connected to a blocking circuit 326, which in this example is a transistor (e.g., a wide low-resistance NFET device), that is connected in the path of a programming input 315 (e.g., an Fsource to a set of eFuses of access code storage circuit 312). Transistor 326 is configured to block access to reading an access code stored in eFuse storage circuit 312 by blocking the ability to read the access code via programming input 315. When locking signal 322 is a lock signal (e.g., when comparator circuit 320 generates a lock signal) any manipulation of fuse blow enable programming signal 314 and programming input 315 is ignored because transistor 326 is inactivated to block the electrical path of programming input 315. When programming input 315 is blocked by transistor 326, the contents of eFuse storage circuit 312 may not be accessed via programming input 315. In particular, locking signal 322 is connected to the gate of pass transistor 326 and, therefore, when locking signal 322 is an unlock signal (e.g., a logical 1 value), transistor 326 is turned on and Fsource voltage input 315 is allowed to connect to eFuse storage circuit 312 and programming of eFuse storage circuit 312 may be allowed. Also, reading the contents of eFuses within access code circuit 312 may occur via Fsource voltage input 315. By contrast, when locking signal 322 is a lock signal (e.g., a logical 0 value), transistor 326 is turned off and Fsource voltage input 315 is blocked from connecting to eFuse storage circuit 312 and, thus, any manipulation of fuse blow enable input 314 and fsource voltage input 315 is ignored, thereby blocking the contents of eFuse storage circuit 312 from being read or modified via programming input 315. In an alternative embodiment, the polarity of locking signal 322 may be inverted and transistor 326 may be a PFET device.

In other embodiments, the concepts of blocking circuits 126, 226, and/or 326 may be applied to other access code storage circuits, such as, but not limited to, an antifuse storage circuit or a flash memory storage circuit. In one example, the programming inputs of an antifuse storage circuit may be blocked by a locking signal. An antifuse may be a two-terminal device that is a highly resistive element in its unprogrammed state and is programmed to a low impedance. In another example, the programming inputs, such as the write/read control signals, of a flash memory storage circuit may be blocked by a locking signal.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A programmable locking mechanism for an integrated circuit, the locking mechanism comprising:
an access code storage circuit for storing an access code, said access code storage circuit having a programming input for programming the access code into said access code storage circuit;
a code input register for receiving an input code;
a comparator circuit in communication with said access code storage circuit and said code input register, said comparator circuit having a output, said comparator circuit comparing the access code to the input code and generating an unlock signal to said output when the input code matches the access code and generating a lock signal to said output when the input code does not match the access code; and
a blocking circuit having a first input in communication with said output, said blocking circuit being configured to block access to reading or modifying the access code via said programming input when said output includes a lock signal.

2. A locking mechanism according to claim 1, wherein said lock signal corresponds to a logical 0 value and said unlock signal corresponds to a logical 1 value.

3. A locking mechanism according to claim 1, wherein said lock signal corresponds to a logical 1 value and said unlock signal corresponds to a logical 0 value.

4. A locking mechanism according to claim 1, wherein said output is in communication with the integrated circuit for blocking access to one or more portions of said integrated circuit when said comparator circuit provides a lock signal.

5. A locking mechanism according to claim 1, wherein said access code storage circuit comprises:
one or more e-fuses, each of said one or more e-fuses configured to include an access code bit of said access code; and
a fuse blow enable input to said one or more e-fuses;
wherein said programming input includes an fsource input for programming said one or more e-fuses.

6. A locking mechanism according to claim 5, wherein said blocking circuit blocks said fsource input when said output includes a lock signal.

7. A locking mechanism according to claim 6, wherein said blocking circuit includes a transistor having a gate in electrical communication with said output, said transistor blocking said fsource input when said output includes a lock signal.

8. A locking mechanism according to claim 5, wherein said blocking circuit blocks said fuse blow enable input when said output include a lock signal.

9. A locking mechanism according to claim 8, wherein said blocking circuit includes an AND gate.

10. A locking mechanism according to claim 5, wherein said access code storage circuit further comprises:
one or more latches in electrical communication with said comparator circuit; and
an e-fuse sense circuit, each of said one or more latches being in communication with a corresponding one of said one or more e-fuses via said e-fuse sense circuit, said e-fuse sense circuit being configured to sense the access code bit from each of said one or more e-fuses and communicate the access code value to said corresponding one of said one or more latches.

11. A locking mechanism according to claim 1, wherein said access code storage circuit includes a flash memory device.

12. A locking mechanism according to claim 1, wherein said access code storage circuit includes an antifuse.

13. A programmable locking mechanism for an integrated circuit, the locking mechanism comprising:
an access code storage circuit for storing an access code, said access code storage circuit including:
one or more e-fuses, each of said one or more e-fuses configured to include an access code bit of said access code;
a fuse blow enable input to said one or more e-fuses for controlling access to programming said one or more e-fuses; and
an fsource input for programming said one or more e-fuses;
a code input register for receiving a input code;
a comparator circuit in communication with said access code storage circuit and said code input register, said comparator circuit having a output, said comparator circuit comparing the access code to the input code and generating an unlock signal to said output when the input code matches the access code and generating a lock signal to said output when the input code does not match the access code; and
a blocking circuit having a first input in communication with said output, said blocking circuit being configured to block access to reading or modifying the access code via said programming input when said output includes a lock signal.

14. A locking mechanism according to claim 13, wherein said output is in communication with the integrated circuit for blocking access to one or more portions of said integrated circuit when said comparator circuit provides a lock signal.

15. A locking mechanism according to claim 13, wherein said blocking circuit blocks said fsource input when said output includes a lock signal.

16. A locking mechanism according to claim 15, wherein said blocking circuit includes a transistor having a gate in electrical communication with said output, said transistor blocking said fsource input when said output includes a lock signal.

17. A locking mechanism according to claim 13, wherein said blocking circuit blocks said fuse blow enable input when said output include a lock signal.

18. A locking mechanism according to claim 17, wherein said blocking circuit includes an AND gate.

19. A programmable locking mechanism for an integrated circuit, the locking mechanism comprising:
an access code storage circuit for storing an access code, said access code storage circuit including:
one or more e-fuses, each of said one or more e-fuses configured to include an access code bit of said access code;
a fuse blow enable input to said one or more e-fuses for controlling access to programming said one or more e-fuses; and
an fsource input for programming said one or more e-fuses;
a code input register for receiving an input code;
a comparator circuit in communication with said access code storage circuit and said code input register, said comparator circuit having a output, said comparator circuit comparing the access code to the input code and generating an unlock signal to said output when the input code matches the access code and generating a lock signal to said output when the input code does not match the access code; and
a blocking circuit having a first input in communication with said output, said blocking circuit being configured to block access to reading the access code via said programming input by blocking said fuse blow enable input when said output includes a lock signal.

20. A locking mechanism according to claim 19, wherein said blocking circuit includes an AND gate for blocking said fuse blow enable input.
